(19) United States
(12) Patent Application Publication
(10) Pub. No.: US 2002/0179891 A1
(43) Pub. Date: Dec. 5, 2002

(54) Device for lifting cover or the like

(76) Inventors: Hans Schuller, Sachsenheim (DE); Ralf Kledig, Bietigheim-Bissingen (DE)

Correspondence Address: Pauley Petersen Kinne & Erickson, Suite 365, 2800 W. Higgins Road, Hoffman Estates, IL, 60195, US

(21) Appl. No.: 10/038,101

(22) Filed: Jan. 2, 2002

(30) Foreign Application Priority Data
Jan. 2, 2001 (DE) 101 00 045.6

(51) Int. Cl. B66F 3/00

(52) U.S. Cl. 254/131

(57) ABSTRACT

The invention relates to a jack for manhole covers or the like, said jack having wheels (36) disposed in the lower region of a hand lever (38) laterally on a transversely extending axle, and said jack having a rigidly forwardly projecting lifting arm (31) which has at least one hook (43), protruding on its underside, to hook in a cover opening. A simple lifting of the cover is achieved when a support device (40, 46, 39), which is also provided in the lower region of the hand lever (38), is mounted in front of the wheels (36), by means of which device the jack (1) is supported when attached to the cover (2) prior to the lifting thereof and in a first lifting phase externally of the cover edge, while the wheels (36) are off the ground (FIG. 1).

### FIELD OF THE INVENTION

The invention relates to a jack for manhole covers or the like, said jack having wheels disposed in the lower region of a hand lever laterally on a transversely extending axle, and said jack having a rigidly forwardly projecting lifting arm which has at least one hook, protruding on its underside, to hook in a cover opening.

### BACKGROUND OF THE INVENTION

A jack of this type for lifting manhole covers is assumed to be known (without published evidence). A hook, situated on a forwardly projecting lifting arm, is hooked into a cover opening and is disposed between the wheel axle and the centre of gravity of the cover, generally in the upper edge region of said cover facing the wheels of the jack. If the hand lever, which projects inclinedly upwardly (rearwardly) away from the cover, is now pivoted downwardly using a handle situated thereon, the rear part of the cover, facing the wheels, is initially raised until it comes to rest in the region of the underside of the lifting arm, and subsequently the front region of the cover is raised from its holder. In such case, the centre of gravity of the generally relatively heavy cover is situated comparatively far removed from the wheel axle, which forms the centre of gravity for lifting the cover. Therefore, a correspondingly large force has to be applied to the hand lever, and it is also difficult subsequently for the jack to move aside the hoisted cover.

The basic object of the invention is to provide a jack of the initially mentioned type, whereby the operation of lifting the cover is facilitated.

This object is achieved by the features of claim 1. According to this, provision is made for a support device, which is also provided in the lower region of the hand lever, to be mounted in front of the wheels, by means of which device the jack is supported when attached to the cover prior to the lifting thereof and in a first lifting phase externally of the cover edge, while the wheels are off the ground. With these measures, more especially in the initial lifting phase, the hoisting of the cover from its holder is substantially facilitated, since the support during lifting is rendered possible as close to the facing cover edge as possible, e.g. as close to the centre of gravity of the cover as possible. Only after a rearward pivotal movement of the hand lever does the jack move onto the wheels, i.e. in a lifting phase, in which the centre of gravity of the cover has already shifted relatively close to the vertical over the wheel axle after the cover has been pivoted rearwardly. In this phase, the jack, together with the cover, can now be easily maneuvered on the wheels.

The easy lifting of the cover in the initial phase is assisted when the support device has at least two lift supports, which are spaced apart from each other when viewed with respect to the transverse direction and are to be supported on the ground close to the cover edge, or it has one transversely orientated lift bar.

For the simple rolling movement during the lifting of the cover as far as the transition to the wheels, the measures are advantageous when the support device has one runner extending in the transverse direction or has at least two convexly downwardly curved runners which are spaced apart from each other when viewed with respect to the transverse direction and extend forwardly from behind.

Furthermore, the lifting process as far as the transition to the wheels is facilitated when a lowermost region of the runner(s) is off the ground, with hooks hooked-in but the cover not yet lifted, and the support in this phase is effected solely with the lift support/supports.

A simple lifting of the cover in the initial phase and a wide pivotal range into the position of the jack, in which the centre of gravity of the cover is displaced as far as possible into the region of the vertical over the wheel axle, are achieved when the construction is designed in such a manner that, when the hook is hooked-in but the cover has not yet been lifted, the hand lever is orientated vertically upwardly or slightly (up to 20°) forwardly. With these measures the jack can also be hooked particularly easily into the corresponding cover opening with at least one of its hooks since it can be positioned easily.

The disposition of the jack with its support device as close as possible on the cover edge and a simple hooking-in operation are assisted when the hook is mounted so as to be displaceable along the lifting arm and/or mounted in an oscillatory manner.

For the simple actuation of the hook, moreover, provision may be made for the hook to be connected to an upwardly orientated rod for operating purposes.

To lift particularly heavy covers, it may be advantageous for an additional hook to be provided, which is connected to the hand lever by means of a holder so as to displaceable via a cable. In such case, more especially with regard to the support device, the additional hook may be hooked in a corresponding cover opening in front of the centre of gravity of the cover.

In order to support in a stable manner the rear upper region of the cover facing the support device, provision is also made for the support device to have at least one stop member mounted in front of said device, as an abutment, for an upper edge region of the cover in its lifted state. A specific stable system is thereby achieved when the stop member is defined rearwardly with a downwardly orientated shoulder portion.

In order to be able to displace the hand lever with the lifting arm horizontally relative to the wheels and a part of the support device, provision may also be made for at least one part of the support device to be connected to the lower region of the hand lever via a horizontal pivot joint with a vertical axis of rotation, the wheels also being disposed on the part.

Furthermore, for an adaptation of the hand lever and as small dimensions as possible for storage, the measure is advantageous when the length of the hand lever is telescopically adjustable.

### DETAILED DESCRIPTION OF THE DRAWINGS

The invention is explained more fully hereinafter with reference to embodiments and with reference to the drawings. In the drawings:

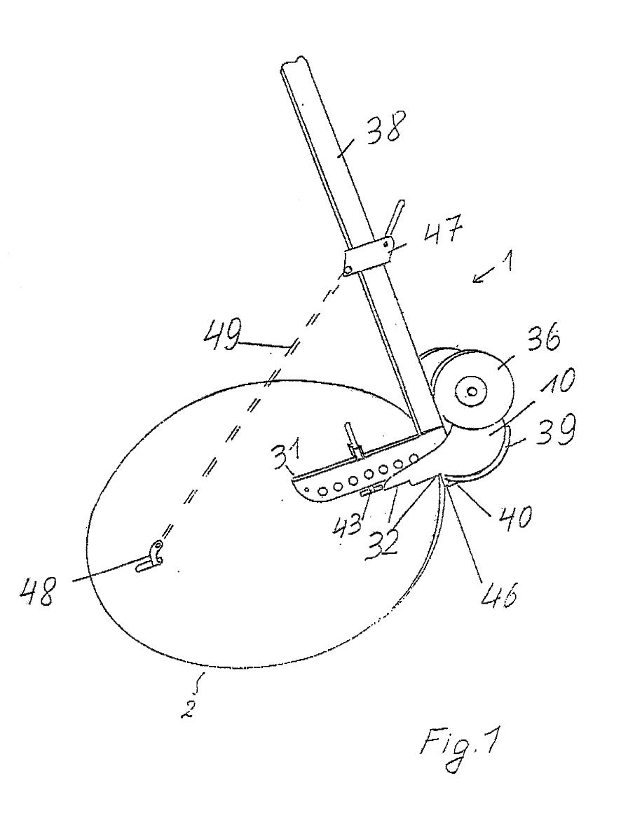

FIG. 1 is a perspective view of a jack attached to a manhole cover;

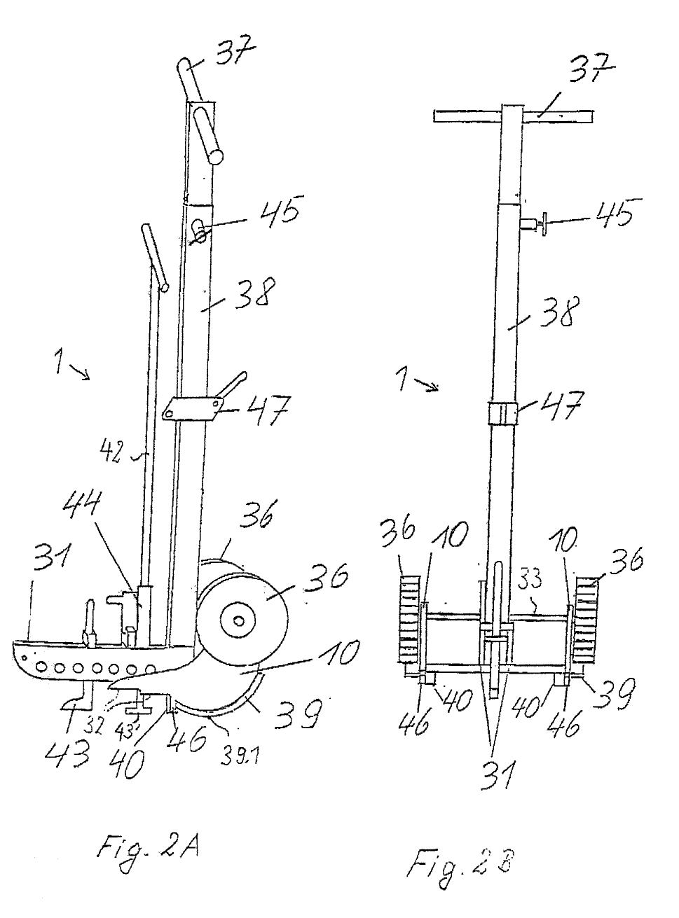

FIGS. 2A and 2B are the perspective side elevational view and front view respectively of a somewhat modified jack according to FIG. 1; and

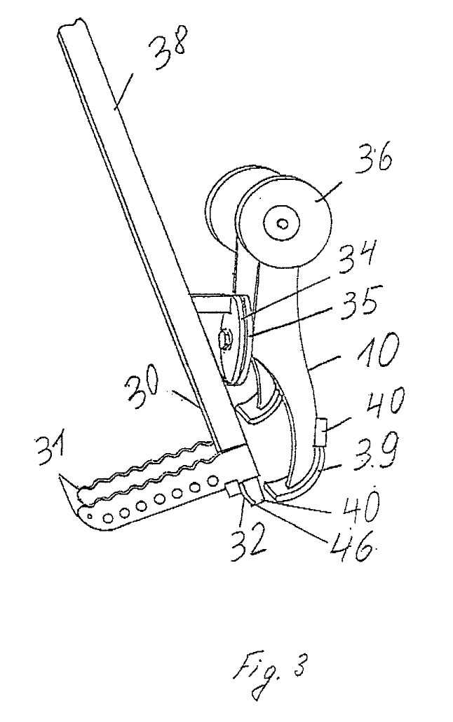

FIG. 3 is a perspective view of an alternative embodiment for a jack.

FIG. 1 illustrates a jack 1 for manhole covers 2 or the like, which is supported on the ground externally of the cover edge by a support device provided on a base member 10 and protrudes beyond the cover 2 with a lifting arm 31 which projects forwardly from the support device. A hook 43, which protrudes on the underside of the lifting arm 31 and is attached to said arm, is inserted into a cover opening and hooked in the cover 2. Rigidly connected to the rear region of the lifting arm 31 is a hand lever 38 which, for example, projects upwardly substantially at right angles. Substantially beneath the hand lever 38, the support device has two lift supports 46 (cf. also FIG. 2B), which are laterally offset from each other transversely relative to the lifting arm 31 and are supported on the ground close to the cover edge. Behind the lift supports 46, when viewed from the cover edge, the support device has two parallel, downwardly convexly curved runners 39 which are spaced apart from each other transversely relative to the lifting arm 31, and the front end region of which runners extends substantially to the lift supports 46, as is also apparent from FIGS. 2A and 2B. Moreover, when viewed with respect to the transverse direction, rubber securing means 40 are mounted adjacent the lift supports 46, provided on the inside thereof, which securing means serve to ensure a better grip of the jack 1 erected externally of the cover edge. In the rear region of the base member 10, two wheels 36 are attached laterally to a transversely extending, horizontal wheel axle 33.

As is also apparent from FIG. 1, an additional hook 48, which is to hook in the front region of the cover 2, may be connected to the hand lever 38 by means of a holder 47 via a cable 49 (shown by dashed lines).

As FIG. 2A also illustrates, the hook 43 with a short shank may be mounted on the lifting arm 31, that is to say so as to be displaceable relative to said arm in the longitudinal direction and preferably in an oscillatory manner for it to hook easily into the cover opening. Alternatively, the hook 43′ with a rod guiding means 44 can be attached to the lifting arm 31 so as to be displaceable also in the longitudinal direction of said arm and may be connected to an upwardly protruding rod 42 for the insertion of the hook 43′ and rotation thereof. Generally one hook 43, 43′ is sufficient but, if necessary, a plurality of hooks may also be provided transversely so as to lie adjacent one another, depending on the disposition of the cover openings.

As also shown in FIGS. 1, 2A and 2B, the convexly downwardly curved runners 39 are provided on the underside of the base member 10 which has, in its front region on its underside opposite the lower end of the lift support 46, two upwardly spaced-apart stop member portions 32 which are separated from each other via a downwardly orientated shoulder portion, the front stop member 32 being higher than the rear one. The stop member serves as an abutment for the upper facing edge region of the cover 2 during the lifting operation. The front stop member may be used, for example, to lift a grid-like manhole cover, where the first lattice is offset a relatively long way to the back. The two base members 10 are connected to the wheel axle 38 by their rear region.

The hand lever 38 has a telescopic configuration, wherein an upper telescopic portion is inserted as an internal tube into a lower telescopic portion and is securable in a desirable extended position by means of a locking mechanism 45. A transversely orientated handle 37 is provided on the upper telescopic portion.

To lift the cover 2, the jack 1 is simply positioned on the edge of the cover 2, the lift supports 46 being supported on the ground close to the cover edge, and the hook 43 being hooked into the corresponding cover opening simply by displacement of the jack 1. In such case, the jack only stands on the ground with the rubber securing means 40 or resp. also with the lift support 46, the end of which lies only slightly above the end of the rubber securing means 40, while a lowermost point 39.1 of the runners 39 in this hooked-in state is off the ground. In such case, the hand lever 38, which is securedly attached by its lower region to the lifting arm 31, is orientated substantially vertically upwardly or inclined somewhat forwardly above the cover 2. In this position, the wheels 36 are relatively far off the ground.

If the hand lever 38 is now pivoted rearwardly, the cover side facing the jack 1 is initially raised until the rear edge abuts against the rear stop member 32. During the further rearward pivotal movement, the front region of the cover 2 is lifted. Also during the rearward pivotal movement, the support for the jack passes from the lift supports 46 to the runners 39, and the cover can easily be lifted further, since the point of support on the ground is always still as close to the centre of gravity of the cover 2 as possible. The rolling operation via the fixed runners 39 permits easy handling during a stable pivotal movement. If, during the further progress of the rearward pivotal movement, the centre of gravity of the cover has shifted relatively close to the vertical above the wheel axle 33, the support is transferred to the wheels 36, and the cover 2 can easily be maneuvered on the wheels 36 in this position by the jack 1.

Since the loading arm is always kept as short as possible from the support point to the centre of gravity of the cover 2, the jack 1 can accordingly be easily constructed, whereby it can be easily handled and can have a relatively compact configuration.

An alternative embodiment of the jack 1 is shown in FIG. 3. In such case, a horizontal rotary bearing about a vertical axis, having a first joint member 34 and a second joint member 35 in the form of an upper and lower rotating plate, is provided between the support device or resp. the base member 10 and the hand lever 38. Connected to the base member 10 are the runners 39, an additional rubber securing means 40 as well as the wheels 36, while, in turn, the lifts supports 46 and the rubber securing means 40 are disposed beneath the lever arm 31*, that is to say in the region beneath the hand lever 38. As apparent from this Fig., the lever arm 31*, comprising two lateral plate elements, has on its upper side an undulatory structure for the simple adjustment of the hook 43, 43′. Such a structure may also be provided in the embodiments according to FIGS. 1 to 2B. The rotary bearing permits further maneuverability during the raising and displacement of the cover 2. *Translator's note In the German text “31” has been used until now for “Hebearm” [lifting arm], but here the word “Hebelarm” [lever arm] is used.

1. Jack for manhole covers or the like, said jack having wheels (36) disposed in the lower region of a hand lever (38) laterally on a transversely extending axle, and said jack having a rigidly forwardly projecting lifting arm (31) which has at least one hook (43), protruding on its underside, to hook in a cover opening, characterized in that a support device (40, 46, 39), which is also provided in the lower region of the hand lever (38), is mounted in front of the wheels (36), by means of which device the jack (1) is supported when attached to the cover (2) prior to the lifting thereof and in a first lifting phase externally of the cover edge, while the wheels (36) are off the ground.

2. Jack according to claim 1, characterized in that the support device has at least two lift supports (46), which are spaced apart from each other when viewed with respect to the transverse direction and are to be supported on the ground close to the cover edge, or it has one transversely orientated lift bar.

3. Jack according to claim 1 or 2, characterized in that the support device has one runner (39) extending in the transverse direction or has at least two convexly downwardly curved runners (39) which are spaced apart from each other when viewed with respect to the transverse direction and extend forwardly from behind.

4. Jack according to claim 3, characterized in that a lowermost region (39.1) of the runner(s) is off the ground, with hooks (43, 43′) hooked-in but the cover (2) not yet lifted, and the support in this phase is effected solely with the lift support/supports (46).

5. Jack according to one of the preceding claims, characterized in that the construction is designed in such a manner that, when the hook (43, 43′) is hooked-in but the cover (20) has not yet been lifted, the hand lever (38) is orientated vertically upwardly or slightly (up to 20°) forwardly.

6. Jack according to one of the preceding claims, characterized in that the hook (43, 43′) is mounted so as to be displaceable along the lifting arm (31) and/or mounted in an oscillatory manner.

7. Jack according to one of the preceding claims, characterized in that the hook (43′) is connected to an upwardly orientated rod (42) for operating purposes.

8. Jack according to one of the preceding claims, characterized in that an additional hook (48) is provided, which is connected to the hand lever (38) by means of a holder (47) so as to displaceable via a cable (49).

9. Jack according to one of the preceding claims, characterized in that the support device (39, 40, 46) has at least one stop member (32) mounted in front of said device, as an abutment, for an upper edge region of the cover (2) in its lifted state.

10. Jack according to claim 9, characterized in that the stop member (32) is defined rearwardly with a downwardly orientated shoulder portion.

11. Jack according to one of the preceding claims, characterized in that at least one part (39) of the support device is connected to the lower region of the hand lever (38) via a horizontal pivot joint (34, 35) with a vertical axis of rotation, the wheels (36) also being disposed on the part (39).

12. Jack according to one of the preceding claims, characterized in that the length of the hand lever (38) is telescopically adjustable.
